(19) United States
(12) Patent Application Publication
(10) Pub. No.: US 2019/0295106 A1
(43) Pub. Date: Sep. 26, 2019

(54) Ranking Vendor Data Objects

(71) Applicant: 0934781 B.C. Ltd, Vancouver (CA)

(72) Inventors: Ali Davar, Vancouver (CA); Simon James Hewitt, Vancouver (CA); David Robert Thompson, Vancouver (CA)

(73) Assignee: 0934781 B.C. Ltd, Vancouver (CA)

(21) Appl. No.: 16/165,783

(22) Filed: Oct. 19, 2018

Related U.S. Application Data
(63) Continuation of application No. 14/606,957, filed on Jan. 27, 2015, now abandoned.
Application No. 14/606,957 is a continuation-in-part of application No. 14/537,092, filed on Nov. 10, 2014, now Pat. No. 9,773,272.
(60) Provisional application No. 62/082,088, filed on Nov. 19, 2014.
(60) Provisional application No. 62/082,076, filed on Nov. 19, 2014.

(51) Int. Cl. G06Q 30/02; G06F 16/951; G06F 16/2457

(52) U.S. Cl. CPC G06Q 30/0201; G06F 16/24578; G06F 16/951

(57) ABSTRACT

A system and method of providing web pages of ranked organization to a user. The user may update data about an organization which will cause the ranking to be changed and the webpage regenerated. The system may inform the user or other users of changes to the ranking.

### RELATED APPLICATIONS

This application claims the benefit of: U.S. patent application Ser. No. 14/537,092 filed Nov. 1, 2014, entitled “Recommendation Engine”; U.S. Patent Provisional Application Nos. 62/082,088 and 62/082,076, both filed on Nov. 19, 2014, both entitled “Business Relationship Accessing”. The contents and disclosure of the above are incorporated herein by reference in its entirety.

### TECHNICAL FIELD

The present disclosure relates to methods for operating a system and database of business relationships between organizations. Certain methods are useful for selecting, processing and outputting organization data as a web page, particularly data that is relevant to particular criteria. The system may comprise a computer network accessible via the Internet.

### BACKGROUND

A person looking for a business, product or service will often start with a web search using relevant keywords and visiting several of the websites returned by the search engine. Some third party websites attempt to aid the search by compiling lists of businesses and/or their reviews. Whilst these websites bring a lot of data to the user in one place, the amount of data can be overwhelming and much of it not relevant to a user's narrow parameters. Additionally these websites tend to rely on scraping publicly available data, which may not include some data known only to the business itself, but which would be relevant to the user.

Certain search and advertisement technologies attempt to focus the search by enabling businesses to pay to enhance their place in the search results. The paid results may target a user using his identity or search terms. However, the user now cannot be sure whether the results are organic and relevant or sponsored and biased.

The inventors have appreciated that there is a need to provide a narrowed set of relevant results to a user that is fact-driven, whilst including the businesses being search in the process.

### BRIEF SUMMARY OF THE INVENTION

The inventors have envisaged a database, network, system, and methods for providing a web page to a user, which comprises a ranked list of organizations. The organizations can affect the rankings by entering new data.

In accordance with a first aspect of the present invention there is provided a computer-implemented method of ranking data. The method comprises retrieving and ranking, from a database of organizations, a set of vendors data objects according to predefined criteria; rendering a web page comprising at least a subset of the ranked set of vendor data objects; communicating the web page to a user in response to a user request; responding to a user request to update (business relationship data) on behalf of a particular vendor by (i) providing a user interface to the user to enter relationship data about a vendor data object and a client organization (ii) storing the user-entered data in the database; re-ranking the set of vendor data objects and regenerating the web page if the rankings change.

In accordance with a first aspect of the present invention there is provided a computer system comprising: a database of business relationships between organizations; one or more computer processors; and computer-readable media having instructions for execution by the one or more processors to perform the method of the first aspect of the invention.

The method may determine a change in the rankings as a result of the update of data and communicating the change to the user.

The method may comprise a processor communicating changes in the rankings to other users who are associated with one of the vendor data objects.

The vendor data objects may represent at least one of: a product, a service, or an organization supplying a product or service.

The method may comprise a processor selecting one web page from a plurality of web pages created according to different selection criteria, wherein the selected web page is selected based on the user's Internet activity.

The method may comprise communicating to the user a web ad or web content comprising a link to the web page.

Ranking vendor data objects may comprise weighting their attribute data and/or depend on the attribute data of client data objects that have a business relationship with each vendor data object and/or depend on an amount of connectedness of the vendor data objects to client data objects in the business database.

The method may comprise a processor verifying at least some of the user-entered data.

The method may identify business relationships between vendor data objects and client data object in the database to compute a relationship score for each vendor, wherein the rankings depends on the relationships scores.

The selection criteria may be based on at least two attributes, preferably wherein one is a business segment and the other is a location.

The method may determine, from data about the user or their Internet activity, at least one further criterion for selecting or ranking vendors.

It is therefore possible to maintain a web page of ranked vendors which encourages vendors to continually add data to a database.

### BRIEF DESCRIPTION OF THE DRAWINGS

The invention may be illustrated by the following figures, in which like reference numerals refer to similar elements.

FIG. 1 illustrates a diagram of a network of computers for accessing a database of business relationships.

FIG. 2 is a diagram of agents for interaction between a client device and server.

FIG. 3 is a graph of business relationships between organizations.

FIG. 4 is an illustration of a landing page and update page.

FIG. 5 is a flowchart for displaying a web page and entering data.

FIG. 6 is a flowchart of (a) creating landing pages and (b) selecting ad or web content.

FIG. 7 is a flowchart of a process for outputting data for anonymous clients.

FIG. 8 is a flowchart of a process for verifying new relationships.

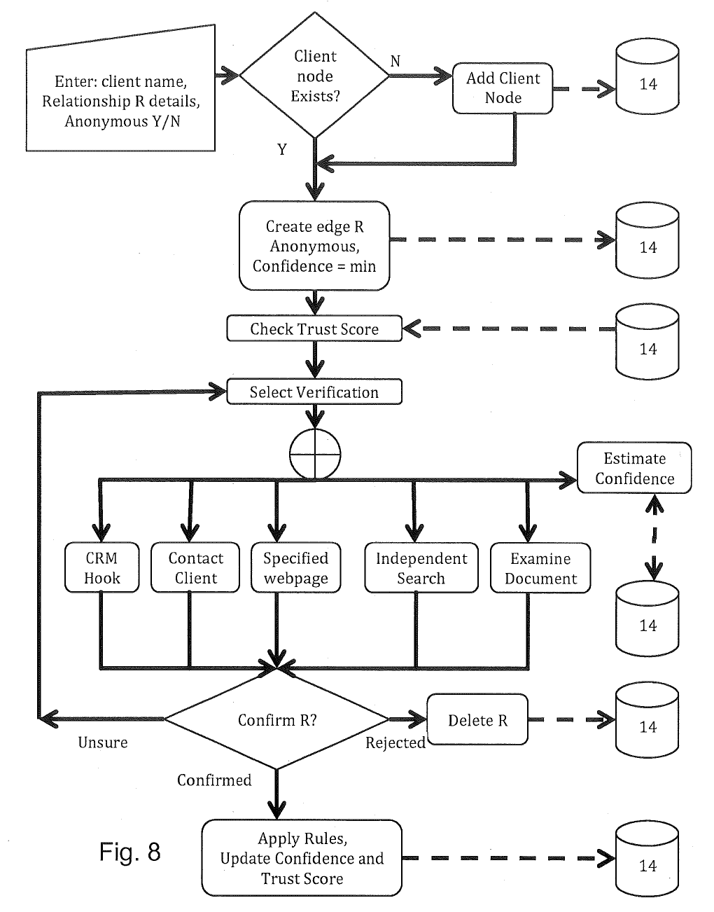

### DETAILED DESCRIPTION

A system comprising a network, database and computer program(s) are implemented to capture business relationships between organizations. The system may be utilized to provide personalized recommendations of organizations according to user-selected criteria, as discussed in co-pending application U.S. Ser. No. 14/537,092 “Recommendation Engine”. The system may also be utilized to generate web pages from pre-defined criteria. The computer program may be conceptually divided into separate modules or agents to provide discreet functions, although in principle there may be less clear boundary in implementing these functions. Agents such as a ranking agent, input agent, and output agent provide a landing page of ranked organizations to a user, which rankings can also be affected by data input by the user.

The web page may be a landing page, having content that is directly accessible by users and also scrapable and indexable by search spiders, which in turn makes the landing page searchable by users who are looking for content about certain organizations, products, services or industries. Landing pages include both organically searchable page and pages optimized for a marketing purpose.

A landing page may be a starting point in a website to which users are directed from a web search or web advertisement in order to find a type of vendor or their product/services. The page comprises content about the organizations that is hopefully relevant to the user, and may also comprise interactive elements, such as a Call-to-action buttons, forms or dynamic content.

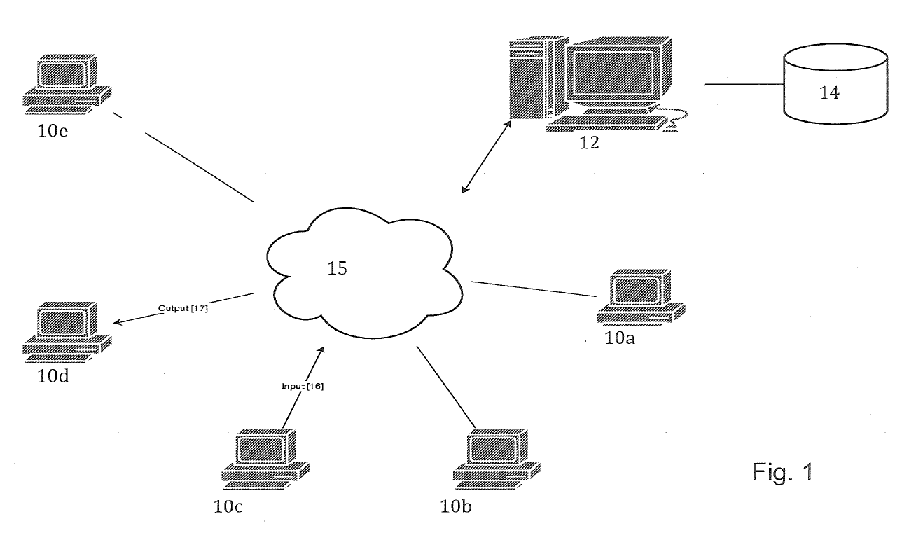

As shown in FIG. 1, the system may be implemented as a network 15 of interconnected computing devices 10a-e and server 12 for inputting and receiving relationship data from a database 14. The database may be a document store, relational database or graph database. Those skilled in the art of computer science will know how to implement such a database and will appreciate that there are other data structures that may be appropriate. The database 14 is connectable to user 10c for receiving data and user 10d for outputting data. The names of these devices are for simplicity of understanding and may be any computing device and each device may be used for a plurality of these roles.

The server 12 may comprise one or more processors for reading instructions from computer-readable storage media and executing the instructions to provide the methods and agents described below. Examples of computer readable media are non-transitory and include disc-based media such as CD-ROMs and DVDs, magnetic media such as hard drives and other forms of magnetic disk storage, semiconductor based media such as flash media, random access memory, and read only memory.

An organization is generally used herein to refer to a legal entity providing or receiving products or services. While an organization may typically be a business, the term includes but is not limited to charities, corporations, sole proprietors, Non-Government Organizations, institutions, government departments, and partnerships. The term vendor is used herein to refer to organizations that supply products or services in a business relationship, notwithstanding that they may also consume products or services in another relationship. A business relationship is generally used herein to refer to a business-to-business (B2B) relationship or commercial transactions between organizations to provide those products or services. Preferably the relationship represents an agreement, which, for example, may subsist in a contract, a terms-of-business document or an ongoing understanding. Most preferably the business relationships stored in the database represent relationships that have been ongoing for at least three months or have at least three repeat instances of transactions. This is in contrast to personal relationships, non-commercial relationships, click-thru data or user website activity data, or one-off commercial transactions. Therefore the strength of the present recommendation is derived from a deep tie between organizations, as recorded in the database. An ongoing, high-value relationship is used as a proxy to suggest that one organization is a worthy supplier of products or services.

A user is generally defined as a person who interacts with a computer, typically entering search criteria, following hyperlinks and viewing results to determine what organizations are recommended. The user is expected to be associated with a particular organization and is seeking a recommendation suited for that organization. In some context, a user is someone entering data into the database about their organization.

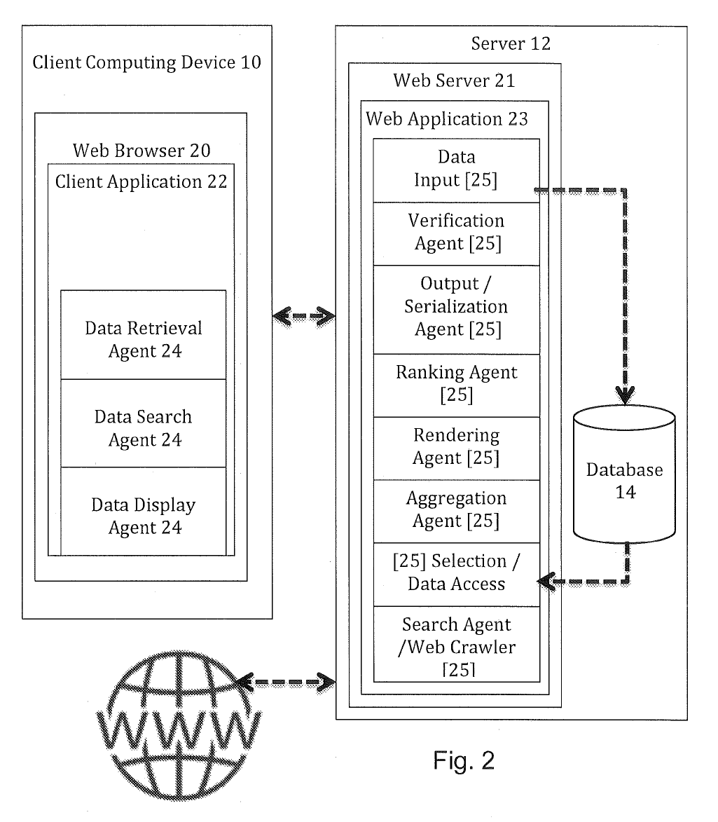

FIG. 2 illustrates the interaction between a client computation device 10 and the server 12 over network 15. The device 10 may interact via a web browser 20 having an application layer 22. The application may use software agents 24 to search the database 14, retrieve output data 17 and display the data on the user's device. The server 12 may be a reverse proxy server for an internal network, such that the client 10 communicates with an Nginx web server 21, which relays the client's request to associated server(s) and database(s) 14. Within the server(s) a web application 23 comprises agents 25 for operating with the database 14.

Users may access the database 14 remotely using a desktop or laptop computer, smartphone, tablet, or other client computing device 10 connectable to the server 12 by mobile internet, fixed wireless Internet, WiFi, wide area network, broadband, telephone connection, cable modem, fibre optic network or other known and future communication technology.

The client device 10 may interact with the server using a web browser using conventional Internet protocols. The web server will use the serialization agent to convert the raw data into a format requested by the browser. Some or all of the methods for operating the database may reside on the server device. The client device 10 may have software loaded for running within the client operating system, which software is programmed to implement some of the methods. The software may be downloaded from a server associate with the provider of the database or from a third party server. Thus the implementation of the client device interface may take many forms known to those in the art. Alternatively the client device simply needs a web browser and the web server 12 may use the output data to create a formatted web page for display on the client device.

The methods and database discussed herein may be provided on a variety of computer system and are not inherently related to a particular computer apparatus, particular programming language, or particular database structure. In preferred embodiments the system is implemented on a server. The term ‘server’ as used herein refers to a system capable of storing data remotely from a user, processing data and providing access to a user across a network. The server may be a stand-alone computer, mainframe, a distributed network or part of a cloud-based server.

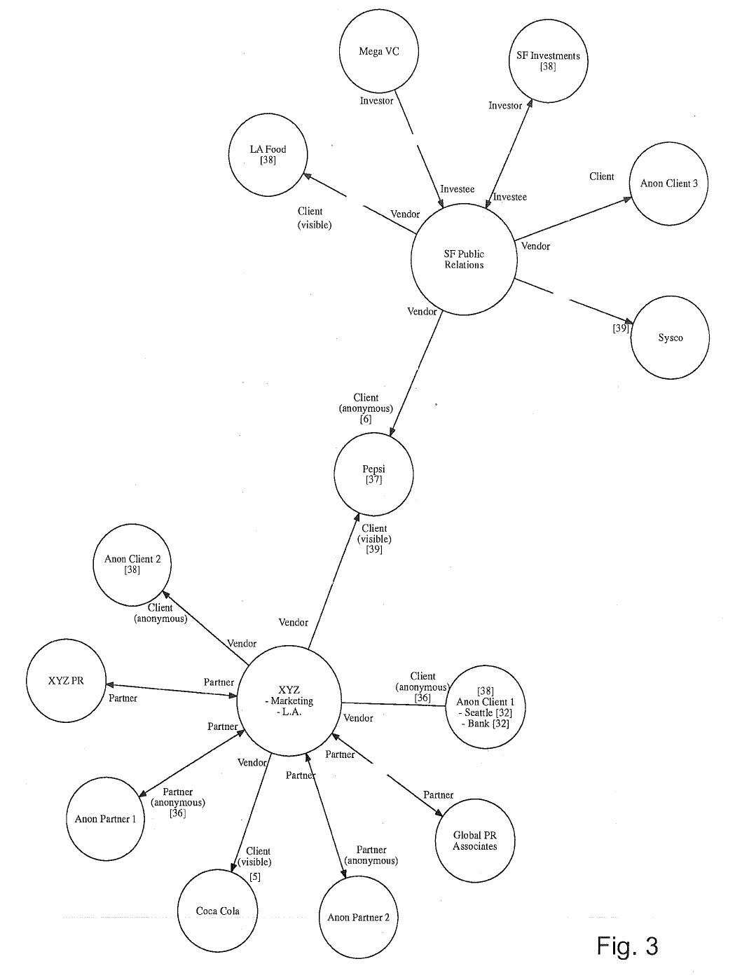

As conceptualized in FIG. 3, the database is structured to record a plurality of relationships 35 with data about the relationships such as the nature of the relationship, attributes 32 about the organizations 38, and identification data (such as a name). A code may be used in the database to indicate that a party is a visible party 39 or an anonymous party 36.

There may be only one relationship recorded for an organization but in most cases there will be many. The database preferably comprises millions of organizations and relationships.

The nature of the relationship may be displayed textually or graphically. The direction is indicated graphically in FIG. 3 using an arrow from the supplier of goods or services to the receiver.

As shown in this example, fifteen nodes 38 representing organizations are interconnected via fourteen relationships 35, indicating which organization in the relationship is a client, vendor, investor, partner, etc. When displaying ‘XYZ's’ profile, four parties will be identified and four parties will be hidden. In the case of ‘Anon Client 1’, the attribute data ‘Seattle’ and Bank may be displayed instead of the party name. As indicated, the ‘Hewitt Corp’ node is marked as visible in the relationship with ‘XYZ’ but anonymous in the relationship with ‘SF Public Relations’.

In contrast to certain social networks, where users may assume pseudonyms and are free to enter fictional data about themselves or others, it is preferred that the present database contain only real parties, their real attributes and their actual relationships. Thus the present system provides methods for authenticating data as well as the users entering the data. In one embodiment, newly entered data is stored in a separate database not visible to viewers. In another embodiment newly entered data is stored in the main database but is marked as ‘unverified’. Immediately or at a later time, a program searches reputable records or websites to corroborate the data. The program may be a web crawler or web scraper. The website may be the official website of one of the parties to the relationship. The reputable record may be a government registry.

The nature of the relationship may be described in general terms (vendor-client, provider-receiver, buyer-seller) or in specific terms (partners, client-advisor, manufacturer-assembler, designer-distributor-retailer, joint venture, client-service provider, investor-investee, parent-subsidiary). Alternative terms will occur to the skilled person as appropriate descriptions of a B2B relationship.

For clarity of the relative position of organizations in a relationship, the terms vendor and client will be used frequently herein but the skilled person will appreciate that other types of organization may be ranked, displayed and used in calculations of relationships.

A relationship record may include relationship attribute data giving further details such as the goods and services, time frames involved, investment amount, product type, sales amount, or terms of the contract. For example, “XYZ has sold reagents to NY Biotech Ltd since 2008, on a non-exclusive basis”. This relationship attribute data provides the user with in-depth understanding of how each organization operates in the business community.

The system may be operated as a social network or online community wherein numerous users input numerous relationships between numerous companies. This allows users to share information with other users. Such sharing on social networks has been found to encourage the newly connected parties to become users themselves and input their own relationships with existing users or potential users, such that the total number of records expands exponentially. Organizations are encouraged to improve the relationship data in the database in order to improve their ranking.

### Database Format

The database may be implemented in a variety of ways known within computing science, such as a document store, object database, relational database or a graph database. Depending on the schema used the data about an organization may be called an object, a record or a node. Generally these may all be called a ‘data object’ to capture the concept of a group of data elements associated with an organization without reference to a specific data schema. For example, a vendor data object may comprise data elements for the vendor itself (e.g. name and location), or products and services that it supplies

In preferred embodiments, a graph database is used, wherein organizations are stored as nodes and business relationships are stored as edges. This is illustrated in FIGS. 3 by lines between organization circles with arrows to indicate the direction of the flow of goods or services from a vendor to a client.

In an alternative data scheme, complete relationships are stored as a table where each relationship record comprises fields for the first and second organization, the nature of the relationship and attribute data for each organization. This allows a relationship to be contained in a single record without the need for pointers to other tables but does require redundant storing of organization attribute data for each record.

### Landing Pages

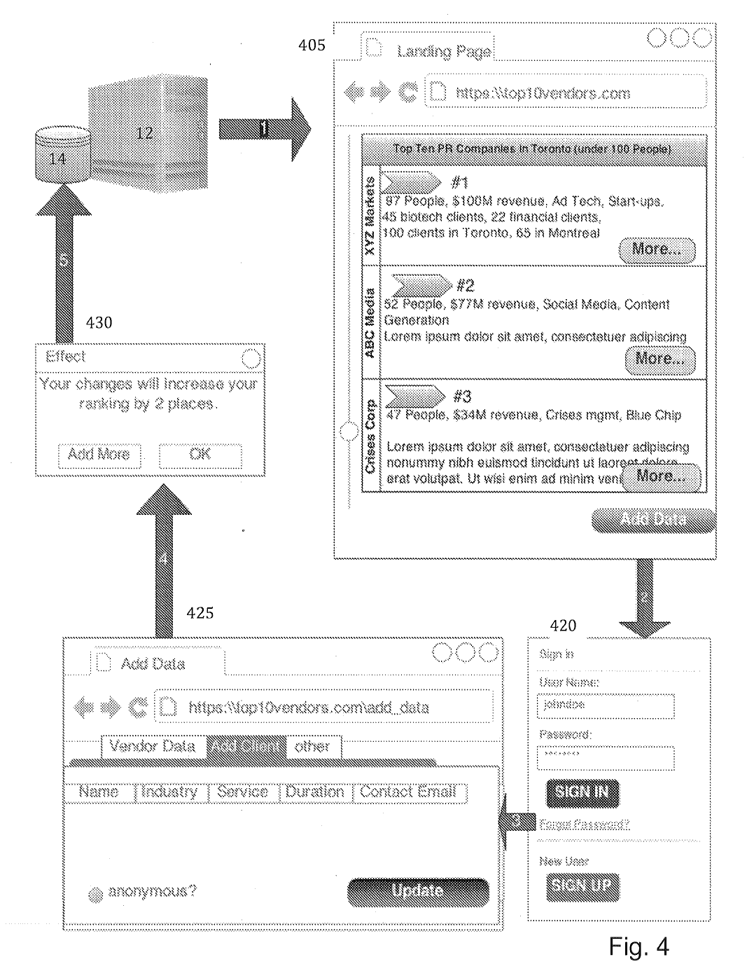

The display of ranked vendor data objects may take many forms. Generally the form will be a web page and preferably the web page is a landing page. A landing page is typically linked from marketing content such as an online ad, report, whitepaper, video or other web content. A landing page may be reached organically by the user via a web search and is usually seen as an entrance to a website or a sales funnel. Either landing page or web page may be used throughout. FIG. 4 shows an example of a landing page and flow of operations to regenerate it from updated data. After being directed to the landing page URL, the user's client computing device receives the landing page from the server 12. The example landing page shows the top ten PR companies in Toronto, employing fewer than 100 people. The vendors are displayed in rank order, showing relevant attribute data and profile data. The page provides links (“More . . . ”) to learn more about a particular vendor.

The page provides a link (“Add Data”) for a user to add data about their organization. After clicking on this link, the user logs in to authenticate that they are associated with a particular organization. The user can then add attribute and vendor-client relationship data, which may improve the ranking of a vendor. For example, the user can enter attribute values like office locations, specialisms, products, services, industries served, or revenue and/or create new business relationship data objects between the vendor and clients. These added or amended data will improve the vendor score and possibly ranking to the extent that these are relevant to the web page selection criteria and ranking algorithms.

The server communicates to the user the effect of their updates on the rankings for the relevant landing page. This may be through a pop up window when the user has finished entering data or in real-time as the user enters data. Some data entries may increase the score of the vendor but not enough to jump another vendor in rank. The ranking agent may calculate this score in real time and communicate to the user in real-time the score relative to other vendors. Some data entries will have no effect on the rankings of a particular landing page but may have an overall effect on its ranking for other recommendations. An overall effect of this process is to create a continual cycle whereby organizations enter data to improve their ranking.

The data is stored in the database 14. At some point, the server 12 regenerates the landing page 405, such that users subsequently arriving at the URL will receive an updated landing page and ranking.

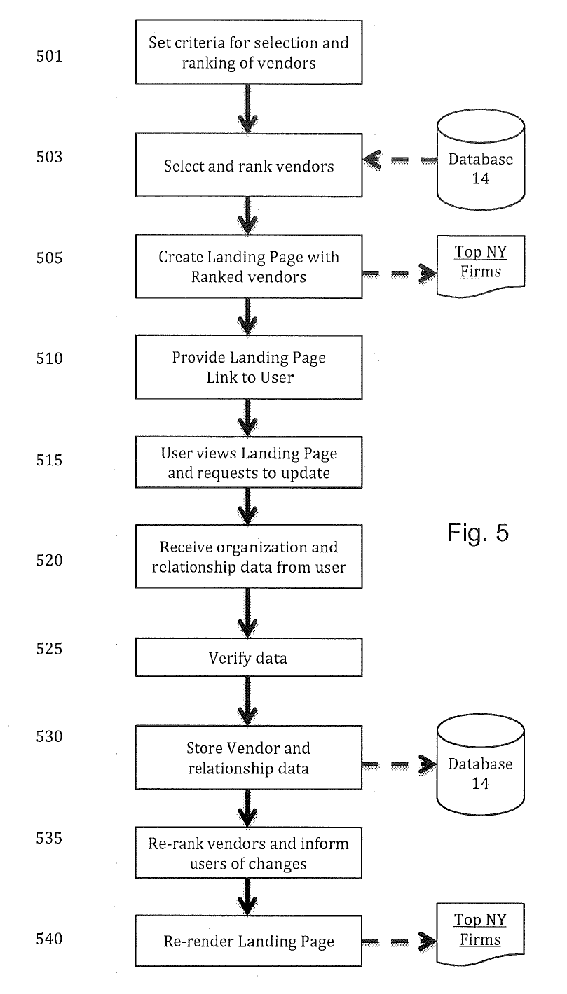

The vendors, products or services displayed on the page are selected by a selection agent, rather than hard-coded by a human web designer, in order to allow the page to be rapidly regenerated as data or criteria are updated. FIG. 5 is a flowchart for ranking, outputting and updating a landing page. The selection agent selects 503 a set of vendor data objects from the business database that satisfy one or more pre-defined criteria 501. A ranking agent ranks the vendor data objects according to a formula to create a set of ranked vendor data objects. Preferably the set of ranked vendor data objects is ordered from the highest scoring or best matching vendor to the Nth highest/matching vendor data object, where N is the number of vendor data objects to be displayed on the landing page.

Thus for a given landing page, the initial rankings are shown consistently to all users, based on the data internal to the database, notwithstanding the possibility that vendor ranking may later be personalized based on the user's organization's connections in the database.

As used herein, a vendor data object is a “match” or “satisfies the selection criteria” if the selection agent can correctly map attribute values in a vendor data object to the selection criteria. The attribute values criteria need not be identical to the criteria, as synonyms and codes may be used instead, such that the selection agent must be programmed to understand the relevancy of an attribute value to selection criteria. For example the selection agent may use a look-up-table (or a dictionary) to translate a keyword in the vendor data object to an industry code (or synonymous word) used as the criteria.

The selection criteria for a landing page is predefined and stored in the database. The criteria may be selected by a system administrator or other human user, possibly as part of a campaign, targeting certain business segments, in a certain location, or that supply a certain client base. There may be several landing pages, each with its own selection criteria and ranking algorithm.

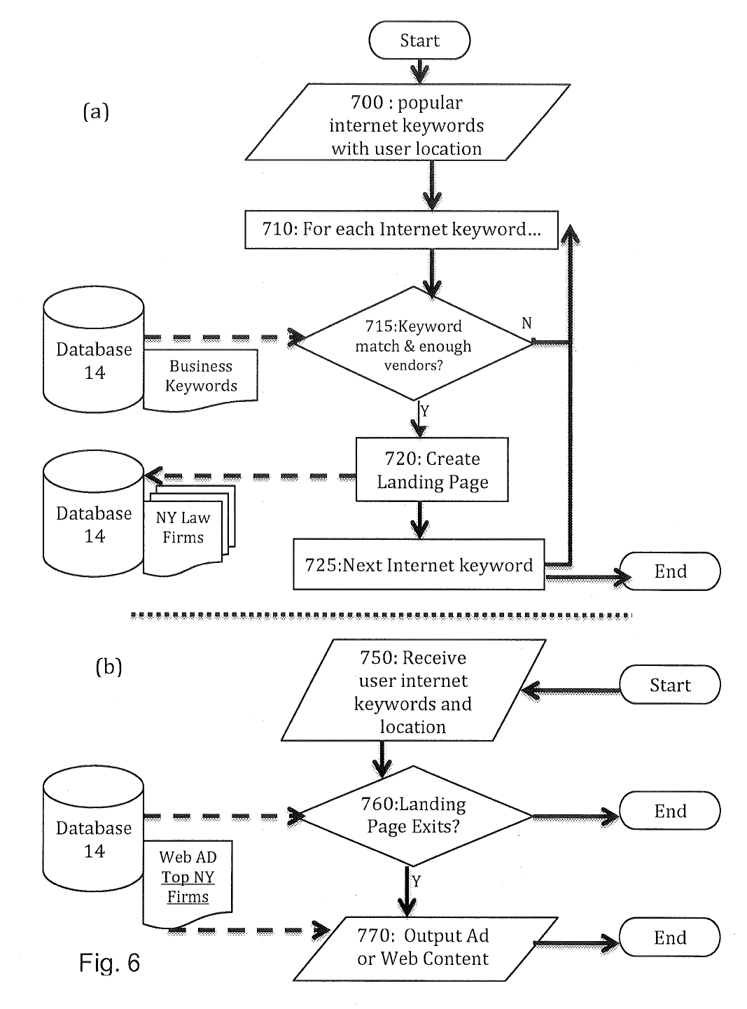

In one embodiment, exemplified in FIG. 6 (a), a search agent monitors (700) Internet activity and keywords, such as words of web searches, Twitter hashtags, and other social media. Some websites such as www.google.com/trends and hashtags.org track popular keywords, which the present system could retrieve. For each popular or currently trending Internet keyword (710) that is a match to business keywords in the database (715) the system creates a new landing page (720) and corresponding selection criteria automatically. For example, the agent may determine that of the thousands of popular search terms, the one most relevant for finding a business, from users in New York, is “Law firms.” The agent then checks whether the database has a service category for “law firms” and whether there are enough vendors in the database that have this attribute value or service category and have a location attribute of New York. If the number of matching vendors is greater than a threshold (715), preferably greater than ten vendors, the agent adds a new landing page to a list of landing pages, stores the selection criteria (Service category: Law Firm and Location: New York) in the database and instructs the creation of a new landing page.

As the rankings depend on the data recorded in the database for the vendors, it is possible for the rankings to change when the data changes, which will be displayed on the landing page when it is next rendered. A user associated with a vendor may update the data for their vendor to change its ranking.

In preferred embodiments, the landing page comprises a link or call-to-action graphic to encourage a user to update data. For example, in FIG. 4 there is an “Add Data” button at the bottom of the landing page. The server responds to a user's clicking this link by providing a login page (if the user is not logged-in already) and then provides a web page comprising a data entry user-interface. The web page enables the user to add or amend data about the vendor (“Vendor Data” in FIG. 4) or its clients (“Add Client”). The user may indicate that a particular relationship is to be kept hidden or anonymous from other users.

As shown in FIG. 5, the verification agent will attempt to verify user-entered data (525). To prevent gaming of the rankings by a user, the ranking agent may ignore some or all unverified data in the calculation of the score or rank of vendor data objects.

As discussed below, the ranking agent may still use the attributes of anonymous relationships in calculating a score or rank of the vendor data objects, although the weight of such data may be lower then visible relationship attributes.

Some changes to a vendor's data may change the rankings for a particular landing page, which may indeed be the purpose of the user's efforts. The system may calculate the ranking changes (535) in real-time with the data being entered or when the user has completed their data entry and then determine whether the rankings have changed. The system communicates any change in the rankings to the user (535). Optionally the system also communicates any changes in the rankings to other users associated with vendors affected by the change. Preferably the determination of changes in rankings is calculated for the user's vendor and the vendors currently displayed on the landing page.

Preferably the system regenerates a landing page (540) after determining that there has been a change in ranking to one or more of the displayed vendor data objects. The regeneration may be performed substantially immediately but other scheduling algorithms may be used. For example the regeneration request may be placed in a queue for periodic, batch, or off-peak processing. The system may alternatively place a flag on the landing page to indicate a ranking has changed and that the server should regenerate the page upon any requests for the page. These delayed processing strategies reduce the number of regeneration operations, particularly when there is a high rate of changes compared to page requests.

A user may arrive at a page by directly visiting a known URL or indirectly through web search results. In one embodiment, depicted in FIG. 6(b) the system places web content or web advertisements that solicit a user to visit a landing page, the content or ad preferably comprising a link to the landing page. The system preferably targets users that appear to be interested in a vendor or business segment, relevant to the selection criteria. For example, the system may be informed (750) that a user has entered certain relevant search keywords, is discussing a relevant topic in a forum, or is visiting a relevant website, wherein there is an opportunity to place web content (such as a report or video) or an advertisement. If a corresponding landing page exists (760), The system bids on this opportunity and, if successful, places the ad or content (770).

Whilst it is preferable that large parts of the landing page are static, there may also be dynamic aspects comprised in the landing page. These dynamic aspects may be resolved on the client computer side or the server side. The dynamic aspects may pertain to additional information about the vendors that are computed or displayed depending on information about the client computer or user, such as cookies stored on the client computer, data passed by the linking web page or ad, IP address of the computer, or identity of the user. For example, the server may determine that the user's computer is 10 KMs from a vendor and display this fact beside the vendor on the landing page. The client computer may select certain text for each vendors based on language preferences or computing capabilities.

### Data Source

The system's data input agent provide one or more ways to input a business relationship to the database, such as a website form, receiving a data file, an API callable by third-party software, and a web crawler. Preferably the relationship is input by a user working for one of the organizations (the asserting organization) and comprises details about the relationship and the other organization (unverified organization). In one embodiment, a web crawler scours the webpages of organizations and/or news websites to find relationships between organizations, in which case both organizations are unverified.

In a preferred embodiment, a user inputs the relationship data. The user registers an account with the present system on behalf of their organization. The user's email domain, LinkedIn account, or Customer Relationship Management software can be used to authenticate the association of the user with the organization.

Preferably the user inputs the relationship details into a user-interface provided by the web server. The interface provides for an option to mark the other organization as ‘anonymous’, i.e. to be hidden from other users. Equivalently the user selects the organization's ‘visibility’ to other users. This status is stored as a flag in the relationship record.

The system stores data for organizations in the database, which can be used to find or compare organizations depending on the nature of the data. The data may be conceptually divided into different categories:

Identification data that enable the system to identify the organization. Identification data includes data such as legal name, parent company name, CEO's name, office address, IP address, logos, brand names, or company registration number;

Profile information about the organization history, expertise, and accomplishments, possibly in an unstructured text format;

Attribute data that describe properties of the organization using categories or values, but do not identify the organization. The attribute data may be sorted and classified according to a structure with defined terms. Attribute data includes classes and values such as industry, sector, general location, specialization, product class, service class, number of employees, market capitalization, field of practice, or revenue; and

Business segment data is a subset of attribute data for describing the business function or division of an organization and includes classes such as industry, sector, specialization, product class, service class, or field of practice. Organizations may be search for, categorized by, or ranked within a particular business segment.

### Classification

An organization may be described according to an infinite array of properties, using a huge variety of terms, many of which are synonymous. In order to group together similar companies and tabulate attribute data by attribute values it is useful to use consistent, defined terms or ranges for the attribute values. Company A may be a baker located in San Jose and have 8 employees. Company B may be a café in San Francisco and have 5 employees. Both may be classified as companies in the retail food and drink sector, located in the San Francisco Bay Area with less than ten employees. This significantly reduces later processing times because there are now a limited number of attribute values to compare.

The database preferably comprises an attribute data structure having a limited number of classes and, for each class, a limited number of standard values. Example classes would be city or number of employees. Example values for these classes would be Boston/London/Madrid or 5-10/100-500, respectively. A classifier agent comprises means to classify data about an organization into a plurality of classes and store them in the database. For example the classifier may be a Decision Tree, Random Decision Forests, or Naïve Bayesian Classifiers available from machine learning tools such as SciKit Learn or Weka. For each standard term there is a vocabulary of synonyms. The classifier parses through an organization's profile data or scrapes the organization's webpage or other records for phrases and terms that are likely to be descriptive of the organization. These phrases and terms are compared to the vocabularies to determine the most suitable attribute value. The attributes are stored in the database for that organization. Tools such as WordNet or algorithms based on co-occurrence statistics enable an algorithm to automate such synonym discovery to classify terms.

Many classes and ranges may have one or more parent values or ranges, such as the NAICS system used to classify industry. For example, a winery could be classed in the Food and Beverage sector, the Beverage subsector, the Alcoholic Beverages group, or the Wine Manufacturing subgroup. Moreover many companies have attribute data in more than one class, such as the largest blue chip companies, which serve many sectors, having products in different classes, and having subsidiary companies with very different employee counts. The database is preferably arranged to store sufficient attribute data to describe the organizations and the system comprises a classifier agent to classify and compare organizations across a plurality of attributes and levels.

### Ranking Engine

The present system implements algorithms to score or rank vendor data objects using a ranking agent. The ranking agent provides a global or personalized metric for ranking vendor data objects. Initially the agent provides rankings for a landing page common to all users and may then personalize the rankings based on the user's identity or user's criteria.

In order to personalize the recommendation of vendors, the ranking agent determines or receives identification data for the user's organization or at least some attribute data for the first organization. Further details about creating a personalized view or ranking of vendors can be found in U.S. patent application Ser. No. 14/537,092, “Recommendation Engine,” incorporate herein by reference.

Initially the agent identifies and retrieves from the database an unordered set of all vendor data objects matching the selection criteria. The ranking agent processes the vendor set to provide a metric for each vendor data object according to a variety of factors.

For the landing page, the agent uses the metric to determine a relative rank of vendor data object then selects a subset of the highest ranked vendors. In one embodiment, the agent computes the metric as a score or rating for each vendor and the vendors are displayed with their score or rating.

The ranking agent may calculate a rough score to select a broad subset of vendors, then perform direct comparisons between close, high-scoring vendors, and then limit the output to a narrowed subset, e.g. of the top N vendors. For example, 1000 vendor data objects may match the selection criteria and are scored according to the match of their services to the selection criteria, from which the 30 highest scoring are selected for further comparison, from which the top ten are ranked and displayed.

The ranking of each vendor data objects may depend upon one or more of: a) the relevance of attribute data of that vendor data object to the selection criteria, b) the weighted sum of certain attributes according to a ranking criteria, c) connectedness in the database of that vendor to other organizations, and/or d) the relevance of vendor data objects to the user's Internet activity.

For example, the selection criteria may be vendors serving a certain industry and a certain location. The set of selected vendor will satisfy both of these criteria and may then be ranked based on: a) the extent that they serve this industry and their proximity to this location, b) the total revenue they generated in this industry and location; c) the number of clients they serve that reside near the location and d) the relevance of the vendors to the user's search query.

For the first consideration, the agent calculates a relevance metric based on the similarity of the product, service, or specialism offered by the vendor and the predefined business segment criteria. For example a shipping company is considered more relevant to the criteria of “shipping services” than a law firm that provides legal service to the shipping industry, eve thought they both have the keyword “shipping” in their records. The reverse recommendation would be made if the selection criteria were, “services to the shipping industry”. The agent determines the attribute type of each selection criteria and retrieves the attribute value for each vendor in that attribute type. Vendor attribute values must satisfy the criteria to even select a vendor, but the ranking agent may additionally determine a degree of matching. For example, many words may be used to describe a vendor's service that match a service criteria but some words may deemed more relevant, and thus contribute to a higher score.

The ranking agent may also weight the relevancy by the extent that the vendor materially succeeds against the criteria. The agent may consider the revenue earned for a service criteria, number of clients that they serve for a client criteria, or number of offices/people they have at a location criteria.

The ranking agent may also employ an algorithm to weight various vendor attributes, such as revenue, employees, years in business, growth, ratings, and awards.

The ranking agent may calculate a connectedness contribution by determining the number of relationships a vendor has to other organizations in the database, preferably only considering or more heavily weighting relationships that provide the products or services relevant to the business segment criteria, or to vendors matching the location criteria, or to clients in a matching client criteria. Thus a vendor who enters many relationships into the database will demonstrate a social proof of competency, particular if their connections are relevant to the selection criteria.

The ranking agent may perform real-time calculations based on Internet activity of the user. This is possible to the extent that user data is provided to the web server by search engines, Demand Side Platforms, cookies on the client computer, or the ad/content directing the user to the landing page. The system selects a landing page for the user from certain user activity and refines the selection or ranking based on additional information about the user. For example, a user's search query or recent Tweets may identify a product of interest to the user, for which a landing page is selected. Additional information about the user's industry or location could be passed to the present system by search engine (via the web ad) to refine the selection of vendor to those that supply the user's location and also to rank vendors based on the similarity of their client base to the user's industry.

The skilled person will appreciate that alternative algorithms and weightings may be used to calculate a metric for each vendor within the spirit of the invention and the invention is not intended to be limited to any particular algorithm.

### Displaying Data

In an example illustrated in FIG. 4, a webpage 405 is displayed in response to a request to see the “Top Ten PR Companies in Toronto’.

Certain quantifiable attribute data may be aggregated and displayed as graphs graphs and charts. For example, for each vendor, the total number of connected clients in each sector or location could be tallied and displayed. The webpage displays that ‘XYZ Markets’ provides “Ad Tech” services specifically, supplies 45 biotech clients and 100 clients located in Toronto. This allows a viewer to make a meaningful interpretation of the huge number of relationships, even when some of the clients are hidden. The user can decide if this company is relevant and click “More . . . ” for a profile page.

Whilst the name of a connected organization may provide a specific example, in many cases it is sufficient to understand an organization's business by evaluating how many of its clients are in a certain sector or location, or have a certain revenue or size. The aggregation agent determines the count of clients with attributes matching each attribute value.

Different attribute values may be selected depending on which attribute values have the highest aggregated count for each vendor or depending on the attribute value's relevance to the selection criteria. For example, a vendor may have ten clients with the value ‘bank’, five clients with the value ‘baker’, twenty clients with the value ‘Boston’ and two clients with the value ‘London’. If the location attribute class is less weighted for a given landing page, it may be ignored or the location value with the highest count (Boston) may be output. Thus for each vendor data object, one or more attribute values are selected based on the relevance of the attribute class and attribute value to the selection or ranking criteria, and their aggregated count is displayed.

The aggregation agent may also aggregate the relationship attributes data for each vendor. The output agent can select the highest count or most relevant relationship attribute value to display. For example, the system can display which firm has the most clients receiving a highly relevant service type.

The system may also create a profile page for a particular vendor and these pages are stored for subsequent retrieval by a user. In this case, the profile page can be rendered offline and retrieved when a particular profile is requested.

To preserve the anonymity wishes of the user the output agent does not output identification data of clients marked as hidden in a particular relationship. The selection agent and ranking agent may still access attribute data, use it to compute metrics, and display the attributes or metrics using the hidden clients but will not display their identification data.

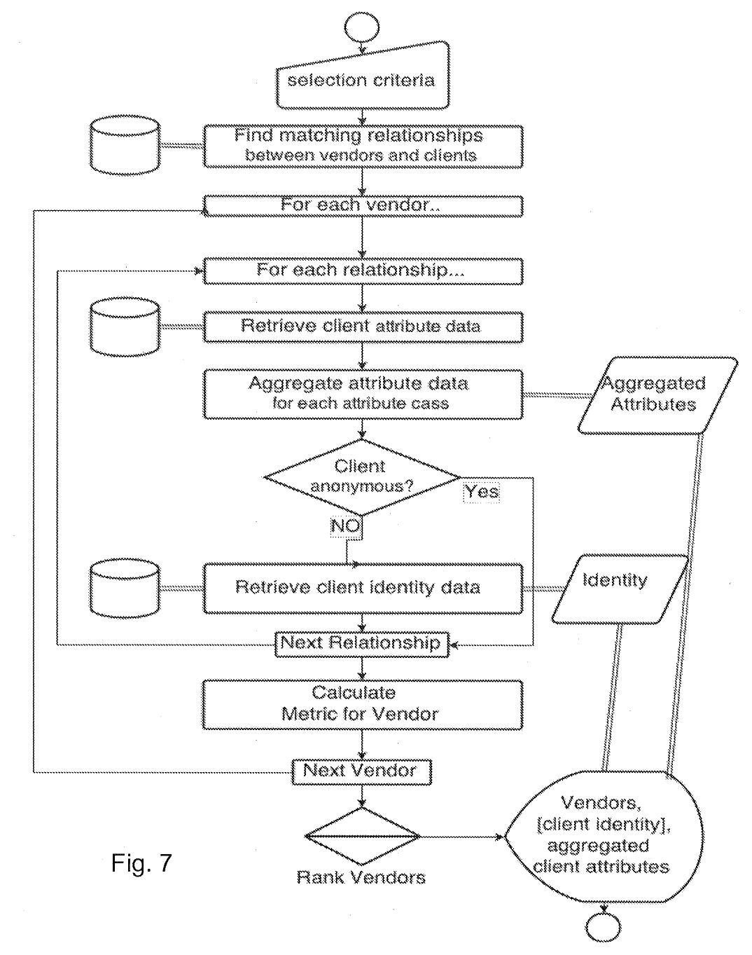

FIG. 7 is an example workflow for retrieving and outputting data from the the database. The example flow depicts a search for vendors, some of which have listed some of their clients as anonymous. As disclosed above, selection criteria are received by the selection agent and matching relationships and organizations are identified in the database. The system iterates through the vendors and relationships in order to compute a score and then rank for each vendor and a subset of ranked vendors is selected for output. Aggregated attributes of anonymous and identified clients are computed and added to the web page.

A serialization agent serializes the web content in a format readable by the web browser and communicates said web content, over a network, to the client-computing device making the request for the landing page.

### Verification

Typically, social networks require both parties in a proposed relationship to confirm the relationship and until such time, certain actions or views are inaccessible. The present inventors have appreciated that in a business context, an organization may have less reason to confirm relationships, even if a user can be found that is appropriately authorized to act on behalf of an organization. Therefore the system is arranged to allow some relationship data to be input by a user that may not be confirmed by the connecting organization and yet still contribute to the ranking. In order to prevent fraudulent gaming of the present social network by a company that claims to be connected to many other companies, the system comprises means, preferably a plurality of means, to verify at least some of the asserted relationships.

Preferably there is a verification agent that determines whether a relationship needs to be verified at all, and if so selects one or more verification schemes to verify an asserted relationship. In order to balance the desire to ensure honest use of the system, user trust in the truth of the database and desire to lessen the burden for inputting relationships, the verification agent preferably uses a sampling algorithm to determine whether an unverified relationship record will be tested. In one embodiment the sampling algorithm generates a random number and compares this to a threshold, preferably wherein the threshold depends on the desired proportion of relationships to test. The threshold may be further customized for an organization depending on its trust score or percent of current relationships that have been verified. For example, in a system implementing a target of 40% verification (Target) and for a company already achieving 55% verified (Current), the verification agent could generate a random number 0.32 (Random) and elect to verify according to either exemplary equation below.

Verify if Random<2*Target−Current (i)

or

Verify if Random<\hat{ }2/Current (ii)

In this numerical example the new relationship would be tested if using equation (i) but not (ii). It is clear that equivalent algorithms may be implemented wherein steps of selecting and implementing a verification scheme are contingent upon the relationship being selected according to a sampling algorithm.

The selection of schemes depends on some measure of trust in the user organization asserting the relationship data. Thus for organizations having a high trust score in the database, the verification agent may select a less rigorous verification scheme or not require verification for at least some relationships. Alternatively or additionally, the selection depends on success of verification schemes previously selected for the asserting organization. Thus if a particular organization's inputted relationships were successfully verified by crawling web content from a particular industry journal, then the verification agent will initially select the web crawling scheme to verify the next relationship. Each relationship data object comprises data about the source of the verification, if any were successful.

In the case of a user entering relationship data, the verification means include a field on a user-interface entry form, which field requests supporting details such as a contact name, phone number or email address for an organization not entering the relationship entry (the unverified organization). The verification agent may check a database to find contact details for an organization or check that any provided contact details are correct. Alternatively the user may input a URL for a webpage where support for the relationship can be found. The verification agent may perform an independent search to determine if the claimed relationship is true.

In one verification method, the verification agent communicates with a person associated with the unverified organization. This URL may be sent by electronic communications means (e.g. email, SMS, instant messenger) to a domain or email owned by the unverified party. The communication may be a unique URL, which enables a user to indicate whether their organization confirms, rejects, or wants to edit the details of the relationship. The agent determines whether the person following the URL came from an authorized email domain or IP address of the second organization. Following the URL may itself may indicate the response or may lead to a website where a choice is made. The website may provide a user with an option to log in using an account verified as associated with the unverified organization or with a Linkedln account, in which case the verification agent checks whether the user works for the unverified organization, preferably having a job title indicative of someone able to act on behalf of the unverified organization. The agent provides the verifying user with an interface to review the relationship data and suggest additions or changes regarding their own organization or the nature of the relationship, including period of the relationship, star-rating, monetary value, or the type of services/goods provided.

In another verification method, the verification agent retrieves a webpage address or electronic document that is input by the user. For example the support may come from a news article, Tweet, press release, contract, invoice, or document submitted to a government body. The agent scrapes the webpage or document, using natural language processing, to determine whether there is support for the relationship as claimed. The scraper can search the metadata in the document markup language for both organization's names, links to their home pages, or to logos which are then cross-reference to a library. The agent scrapes the text for the names of the organizations and words or phrases indicative of a business connection such as “A begins a joint venture with B” and “X supplies legal services to Y.” The business connection words or phrases may be stored as a glossary.

In another verification method, any or all of the steps of entering new relationships, confirming them and maintaining them may be performed by coupling the present system with Customer Relationship Management (CRM) software, such as Salesforce Inc.™ For example a CRM account could be coupled to an account of the present business social network, whereby API calls can synchronize business relationships between accounts. The user may install an add-on to the CRM software which provides the server 10 with permissions to view relationship data. Server 10 may call the CRM's API to perform batch updates or the CRM may call server 10 API for real-time update. This provides some level of confidence in the relationship, with the further benefit of enabling changes to the relationship, including termination, to be updated quickly and seamlessly. The skilled person will appreciate that software other than CRM may be coupled and that such software and the present social network may be part of the same overall system.

In yet another verification method, the verification agent performs an independent search of websites, social media, or third-party databases to corroborate the relationship. Such webpages may include the news and investment webpages of the organizations involved, articles in online industry journals, conference publications, and organization profile pages. Social media sources may include Linkedln, Facebook, and Twitter, where users may post text on an organization's account that supports the claimed relationship. For example, an employee of XYZ Corp could Tweet about a new marketing relationship and contemporaneously enter it on the presently disclosed system. Similar to the case of a user-directed website above, the web crawler preferably detects the co-occurrence of both parties in a single web content, more preferably connected by words that indicate a relationship exists. Third-party database sources include SEC filings, Court records, NIH grants, share dealings, patent offices, investments records, and customs filings. Provided these databases are authenticated as unbiased, the verification agent can scrape these for corroborating data true through their digital portals. The verification agent may maintain a list of authenticated websites comprising news about each industry and verify claimed relationships there. Vice versa, the agent may build such a list from the websites referenced by confirmed relationships. The verification agent may determine the industry of each organization in the relationship, select one or more news websites relevant to those industries and electronically search for the co-occurrence of each organization, as discussed above.

The above verification methods and equivalent variations thereof may be combined in parallel or in sequence to derive a confidence score. The user may select a scheme or the agent may select the scheme according to trust scores and internal rules. These schemes are expected to be run external to the user's experience and may take days to confirm. Confirmation or partial confirmation increases the confidence score by an amount dependent on the verification scheme used. In some cases, the results will be inconclusive, in which case the relationship may retain its initial confidence score. The verification agent may select another scheme if the confidence score is below a threshold.

The verification agent may also estimate the confidence score using trust in an organization as a proxy. For example, the confidence may be set to the trust score of the organization that input the relationship.

As a numerical example, an employee of a large vendor inputs a marketing relationship with a small client. A relationship edge is created with an initial confidence score of 0.3 (out of 1.0) to reflect the vendor's high trustworthiness and small advantage gained for adding a small client. The value is high enough that the relationship counts towards an aggregated count of small clients served by the vendor. The employee enters the email address of her contact at the client. The verification agent sends an email to that address. No response is received after a week and the confidence score remains below the threshold of 0.6 for displaying a relationship, so the employee directs the agent to the vendor's website where the client is mentioned. An ambiguous mention of the relationship is detected by text scraping, so the agent only increases the confidence to 0.4 and so the agent performs an independent search of a marketing journal website. Dominant use of both organization names is detected in a single article, so the confidence score is increased to 0.7. The client's name now appears to viewers on the vendor's profile page. Eventually the client confirms the relationship and the confidence score is increased to 1.0.

The agent may also determine a confidence score using heuristics, game theory, and behavioral modeling to determine, for example, the likelihood that the relationship is possible, whether a user is abusing the system, whether there was an error, or whether the relationship is different to the organization's normal specialism. For example the agent could automatically reject a relationship (on at least three grounds) in which “an oil company has provided legal advice to Greenpeace since 1963”.

The result of the verification process is an update of a confidence score of relationship record. A new unverified relationship may be initialized with a zero (Boolean FALSE) or minimal confidence score. If the verification agent confirms the relationship, it sets the confidence score to one/TRUE/maximum. The skilled person will appreciate that these numerical scores are arbitrary and other ranges or interpretations of scores may be used without departing from the concept of confidence about a relationship record. For example, a non-confidence score may be implemented instead to record the extent that the relationship is not verified.

The verification agent may further comprise heuristic and/or correction algorithms to determine whether the confidence score is fair. For example the agent may comprise a plurality of checks that the confidence score has not been fraudulently elevated by relationship confirmations from dummy organizations or untrustworthy websites. The agent may adjust the confidence score using these heuristic and/or correction algorithms after or as part of the verification and scoring algorithm.

FIG. 12 is an example flowchart for a process of verifying a relationship record. The flowchart is displayed for a user working for a vendor entering details about a relationship R with a client but in principle the process would be similar for a relationship between any two organizations that was input by a search bot or human user.

The user logs onto the vendor account and request to enter a new relationship. They enter the client's name, relationship details, and optionally select to make the relationship anonymous (not visible to other users). If the client does not exist in the database then a new client node is created and a web crawler determines attribute data of the client. A relationship is created in the database, in this case as an edge, having two attributes, anonymous and confidence. The anonymous flag is set to the choice selected by the user and the confidence score is set to a default, typically low, value. As an alternative, the system's rules may default the confidence to a high value, such that relationships are effectively deemed to be true unless proven otherwise.

The results of the selected verification scheme are used to determine whether the relationship is deemed confirmed, rejected, or non-confirmed/unsure. The first two possibilities are derived from a deliberate action by the confirming client or from definitive support found in a webpage. A lack of a response or inconclusive support may be used to select another verification scheme or prompt the vendor for more proof. For a rejection, the relationship record is deleted from the database. For a confirmation, the verification agent considers whether any rules or multipliers are warranted to reduce the confidence score to less than the maximum or to not apply the Boolean, TRUE.

In one embodiment, a recommendation metric for an organization partly depends on the strength of the relationship between organizations and the relationship confidence score. For example, a relationship metric could be calculated as the strength multiplied by the confidence, such that high-value, unverified relationships may still count towards a recommendation metric but will be underweighted until they are verified.

In another embodiment the confidence score is used when performing calculations or displaying relationships. The system may be implemented to output data from both verified and unverified relationships but mark them as such. For example a symbol could be placed next to organizations that have not been confirmed as clients of a particular vendor. Alternatively the system may be implemented to calculate metrics, aggregate attributes, and output data only from those relationships where the confidence score is beyond a threshold value.

Further aspects of verification and trust scoring are discussed in U.S. Patent Provisional Application No. 62/082,088, filed on Nov. 19, 2014, entitled “Business Relationship Accessing”.

Certain terms are used herein interchangeably. For example, aspects that are intended to be hidden from output may be called ‘anonymous’, ‘unidentified’, ‘private’ ‘obfuscated’ or ‘hidden’ whereas those intended for output may be called ‘public’, ‘identified’, or ‘visible’.

The above description provides example methods and structures to achieve the invention and is not intended to limit the claims below. In most cases the various elements and embodiments may be combined or altered with equivalents to provide a recommendation method and system within the scope of the invention. It is contemplated that any part of any aspect or embodiment discussed in this specification can be implemented or combined with any part of any other aspect or embodiment discussed in this specification. Unless specified otherwise, the use of “OR” between alternatives is to be understood in the inclusive sense, whereby either alternative and both alternatives are contemplated or claimed.

For the sake of convenience, the example embodiments above are described as various interconnected functional agents. This is not necessary, however, and there may be cases where these functional agents are equivalently aggregated into a single logic device, program or operation with unclear boundaries. In any event, the functional agents can be implemented by themselves, or in combination with other pieces of hardware or software.

While particular embodiments have been described in the foregoing, it is to be understood that other embodiments are possible and are intended to be included herein. It will be clear to any person skilled in the art that modifications of and adjustments to the foregoing embodiments, not shown, are possible.

1. A computer-implemented method of ranking data, the method comprising:
retrieving and ranking, from a database of organizations, a set of vendors data objects according to predefined criteria;
rendering a web page comprising at least a subset of the ranked set of vendor data objects;
communicating the web page to a user in response to a first user-request;
responding to a second user-request to update business relationship data on behalf of a selected vendor by (i) providing a user interface to the user to enter business relationship data about the selected vendor and a client (ii) adding the user-entered data as a connection object between vendor and client data objects in the database; and
re-ranking the set of vendor data objects using the added data and regenerating the web page if the rankings change.

2. The computer-implemented method of claim 1, further comprising determining a change in the rankings as a result of the added data and communicating the change to the user.

3. The computer-implemented method of claim 1, further comprising a processor communicating changes in the rankings to other users who are associated with one of the vendor data objects.

4. The computer-implemented method of claim 1, wherein the vendor data objects represent at least one of: a product, a service, or an organization supplying a product or service.

5. The computer-implemented method of claim 1, further comprising a processor selecting one web page from a plurality of web pages created according to different selection criteria, wherein the selected web page is selected based on the user's Internet activity.

6. The computer-implemented method of claim 1, further comprising communicating to the user a web ad or web content comprising a link to the web page.

7. The computer-implemented method of claim 1, wherein ranking vendor data objects comprises weighting their attribute data.

8. The computer-implemented method of claim 1, wherein ranking the vendor data objects depends on the attribute data of client data objects that have a business relationship with each vendor data object.

9. The computer-implemented method of claim 1, further comprising a processor verifying at least some of the user-entered data.

10. The computer-implemented method of claim 1, wherein ranking partly depends on an amount of connectedness of the vendor data objects to client data objects in the business database.

11. The computer-implemented method of claim 1, further comprising identifying business relationships between vendor data objects and client data object in the database to compute a relationship score for each vendor, wherein the rankings depend on the relationships scores.

12. The computer-implemented method of claim 1, wherein the selection criteria is based on at least two attributes, preferably wherein one is a business segment and the other is a location.

13. The computer-implemented method of claim 1, further comprising determining, from data about the user or their Internet activity, at least one further criterion for selecting or ranking vendors.

14. The method of claim 1, wherein the ranking of each vendor data object depends on the relevance of attribute data of that vendor data object to one of the predetermined criteria, and connectedness in the database of that vendor data object to other organizations data objects relevant to one of the predetermined.

15. A computer system comprising: a database of business relationships between organizations; one or more computer processors; and computer-readable media having instructions for execution by the one or more processors to:
retrieve and rank, from a database of organizations, a set of vendors data objects according to predefined criteria;
render a web page comprising at least a subset of the ranked set of vendor data objects;
communicate the web page to a user in response to a first user request;
respond to a second user request to update business relationship data on behalf of a selected vendor by (i) providing a user interface to the user to enter business relationship data about the selected vendor and a client (ii) adding the user-entered data as a connection object between vendor and client data objects in the database;
re-rank the set of vendor data objects using the added data and regenerating the web page if the rankings change.
